(19) United States
(12) Patent Application Publication
(10) Pub. No.: US 2026/0099718 A1
(43) Pub. Date: Apr. 9, 2026

(54) SYSTEM AND METHOD TO EFFICIENTLY PROVIDE TASK-SPECIFIC EXPERT

(71) Applicant: Verizon Patent and Licensing Inc., Basking Ridge, NJ (US)

(72) Inventors: Venkata R Avasarala, Woodbridge, VA (US); Nityanand Sharma, Wesley Chapel, FL (US); Gus Attar, Tampa, FL (US); Pradeep K Chettipalli, Piscataway, NJ (US); Venkata Kiran C Vemulapalli, Frisco, TX (US)

(21) Appl. No.: 18/905,232

(22) Filed: Oct. 3, 2024

(51) Int. Cl. G06N 3/091

(52) U.S. Cl. CPC G06N 3/091

(57) ABSTRACT

One or more computing devices, systems, and/or methods for efficiently providing expert systems is provided. One or more relevant datasets are preprocessed and available to the system. A user requests LLM expert insights, such as financial analyst insights, based on user input data. An LLM component is prompted using an expert prompt that includes an expert persona and an expert persona instruction and provides LLM output based on the expert prompt. The LLM output may be presented to the user.

### BACKGROUND

Obtaining a task-specific expert system typically involves fine-tuning or training an already existing machine learning model, in a manner that changes the already existing model in some manner. For example, it typically involves re-parameterizing the model or a portion of the model (e.g., a layer of a neural network model). Such methods can be relatively time-consuming, labor intensive, and/or expensive to implement. Thus, there is a need for methods and systems that provide a task-specific expert in a more efficient manner.

### BRIEF DESCRIPTION OF THE DRAWINGS

While the techniques presented herein may be embodied in alternative forms, the particular embodiments illustrated in the drawings are only a few examples that are supplemental of the description provided herein. These embodiments are not to be interpreted in a limiting manner, such as limiting the claims appended hereto.

FIG. 1 illustrates an example of an environment that includes a system for providing task-specific experts, in accordance with one or more embodiments of the present technology;

FIG. 2 is a flow chart illustrating an example method for providing task-specific experts, and in particular financial analyst experts, in accordance with one or more embodiments of the present technology;

FIG. 3 illustrates an example form of a financial analyst expert persona utilized in one or more embodiments of a system for providing task-specific experts, in accordance with one or more embodiments of the present technology;

FIG. 4 illustrates another example form of a financial analyst expert persona utilized in one or more embodiments of a system for providing task-specific experts, in accordance with one or more embodiments of the present technology;

FIG. 5 illustrates an example form of a generative pretrained transformer (GPT) Large Learning Model (LLM) prompt utilized in one or more embodiments of a system for providing task-specific experts, in accordance with one or more embodiments of the present technology;

FIG. 6 illustrates another example form of a GPT LLM prompt utilized in one or more embodiments of a system for providing task-specific experts, in accordance with one or more embodiments of the present technology;

FIG. 7 illustrates another example form of a GPT LLM prompt utilized in one or more embodiments of a system for providing task-specific experts, in accordance with one or more embodiments of the present technology

FIG. 8 is an illustration of a scenario featuring an example non-transitory machine-readable medium in accordance with one or more embodiments of the present technology;

FIG. 9 is an illustration of a scenario involving various examples of networks that may connect servers and clients in accordance with one or more embodiments of the present technology;

FIG. 10 is an illustration of a scenario involving an example configuration of a server that may utilize and/or implement at least a portion of the techniques presented herein;

FIG. 11 is an illustration of a scenario involving an example configuration of a client that may utilize and/or implement at least a portion of the techniques presented herein.

### DETAILED DESCRIPTION OF EXAMPLE EMBODIMENTS

Subject matter will now be described more fully hereinafter with reference to the accompanying drawings, which form a part hereof, and which show, by way of illustration, specific example embodiments. This description is not intended as an extensive or detailed discussion of known concepts. Details that are well known may have been omitted, or may be handled in summary fashion.

The following subject matter may be embodied in a variety of different forms, such as methods, devices, components, and/or systems. Accordingly, this subject matter is not intended to be construed as limited to any example embodiments set forth herein. Rather, example embodiments are provided merely to be illustrative. Such embodiments may, for example, take the form of hardware, software, firmware or any combination thereof.

Systems and methods are provided for efficiently providing task-specific expert systems, according to one or more aspects of the embodiments disclosed herein. In particular, the embodiments herein are described in detail in the context of financial analyst expert systems. Generally, providing task-specific expert systems may involve providing one or more machine learning models that are specially-trained on the task(s) of interest (e.g., reviewing current earnings reports) and/or training or fine-tuning (e.g., re-parameterizing) existing machine learning models. As models have become larger and more complex (e.g., large language models), the process of re-training or fine-tuning such models to better fit specific tasks can be cost and time-inefficient for many users. Fortunately, the systems and methods disclosed in the embodiments herein make it possible for users to implement task-specific expert systems without having to re-parameterize a large model. In particular, the systems and methods of the embodiments disclosed herein utilize certain “prompt engineering” techniques to accomplish the provision of tailored task-specific expert systems, and in particular, task-specific natural language expert systems, without needing to re-parameterize or fine tune a large language model. Accordingly, by utilizing the techniques disclosed in the embodiments herein, a user may build and implement more efficient expert systems.

The disclosed techniques allow for improved expert systems that leverage one or more GPT language models to provide task-specific expert service without the need to re-parameterize or fine tune the GPT language models. In the embodiments, one or more expert persona are generated and utilized to prompt a GPT LLM such that the LLM behaves as a finely-tuned expert fit for a specific task, without having to re-parameterize the LLM or any layer or aspect thereof.

In the embodiments disclosed herein, the tasks for which the embodiments are primarily illustrated and described are certain financial analyst tasks. Note, however, that the embodiments disclosed herein are not limited solely to those tasks expressly disclosed, but may generally comprise any suitable tasks such as, for example, scientific discovery tasks, research and development tasks, teaching assistant tasks, etc., to engineer a suitable prompt-based expert system.

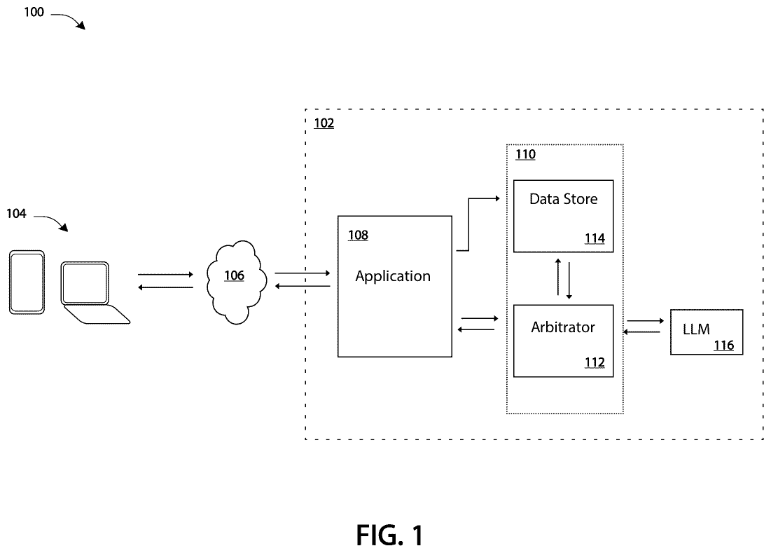

FIG. 1 illustrates an example of an environment 100 that includes expert system 102 for providing task-specific experts, including financial analyst experts, using one or more generative pretrained transformer LLMs. Note that unless context dictates otherwise, as used herein, the terms large language models and LLMs may be used interchangeably and may be understood to refer to generative pretrained transformer large language models. In general, expert system 102 may have any architecture and be configured in any manner sufficient to provide the functionality disclosed herein. In some embodiments, system 102 may be implemented at least in part using a web application architecture, hosted on-premise and/or wholly or partially in the cloud. In general, expert system 102 may be implemented using one or more servers, databases, storages, etc., running on one or more computing devices or host machines. Portions of the expert system 102 may run on one or more client devices, such as personal computing devices 104. In some embodiments, the components, portions, etc. of expert system 102 and implementing servers, databases, storages, etc. may be communicatively coupled via one or more network(s) 106. Network(s) 106 may comprise the internet, intranets, extranets, local area networks (LANs), wide area networks (WANs), wired networks, wireless network (using wireless protocols and technologies such as, e.g., Wifi or cellular), or any other network suitable for providing data communications between two machines, environments, devices, networks, etc. In one or more embodiments, the one or more servers, databases, storages, etc. may be implemented on networked dedicated host machines; in other embodiments, they may be hosted as services in one or more service provider environments. In general, a service provider environment may comprise on-premise or hosted cloud infrastructure, platform, and/or software providing various servers, databases, data stores, and the like.

In some embodiments, expert system 102 may comprise application 108, LLM framework 110 (comprising arbitrator 112 and data store 114), and LLM component 116. In general, application 108 may comprise one or more software applications, servers, programs, services, microservices, components, models, code portions, scripts, modules, stores, and the like, that are generally configured to provide backend functionality, server to client functionality, and/or web application functionality, to one or more additional software applications, programs, components, apps, scripts, or modules, and the like, such as a web browser (not shown), running on one or more client devices (e.g., personal computing devices 104). In some embodiments, application 108 may be configured to provide certain front end functionality (e.g., providing user interface(s) to client devices) for performing user functions such as inputting user data and user requests and receiving responses to those requests from system 102.

In some embodiments, application 108 may be tightly or loosely coupled to LLM framework 110. In general, an LLM framework of the embodiments disclosed herein (e.g., framework 110) may be any suitable LLM framework that is architected, configured and deployed in any suitable manner sufficient to provide the functionality described herein. As shown in FIG. 1, in some embodiments, framework 110 may comprise an LLM arbitrator portion (e.g., arbitrator 112) communicatively coupled to one or more data stores (e.g., data store 114). Generally, arbitrator 112 may comprise any suitable LLM framework portion, environment, functionality, components, services, etc. sufficient to provide the functionality described herein.

Such functionality may include, for example: interfacing (tightly or loosely, via API or otherwise) with application 108, LLM 116, and data store 114; providing an environment, tools, etc. for prompt and prompt template creation, curation and storage; providing an environment, tools, etc. for creating, editing and curating code; executing methods, functions and/or code and controlling flow of interactions (e.g., via prompts) with LLM 116; providing an environment, tools, etc. for curating and storing data sources (e.g., documents, lookup tables, databases, APIs, etc.); etc. In some embodiments, LLM arbitrator 112 may comprise an instance of a commercially available service or product such as, e.g., NeuralSeek® or Langchain™.

In general, LLM component 116 may comprise one or more generative natural language models (e.g., GPT LLMs) configured to perform and/or capable of being prompted to perform, one or more natural language tasks, including generating one or more insights based on one or more files, data structures, streams, etc. containing natural language text (including numerical text). In particular, in the embodiments described herein, LLM component 116 is capable of being prompted to perform one or more tasks in relation to one or more user inputs containing one or more user requests, using a role (frame of reference context) defined and/or described by one or more expert personas, and with respect to illustrative embodiments, as financial analysts, as described in more detail below. LLM component 116 may run on the same or different computing device, processors, and/or processing environment as framework 110 and/or application 108. In some embodiments, the one or more LLMs of LLM component 116 may comprise one or more on-premise models and/or one or more connected services provided by, e.g., Mistral AI™ (Mixtral™), OpenAI™ (GPT-4o™), Anthropic™ (e.g., Claude 3™), Meta® (MetaCLIP™), Google® (Gemini™), etc.

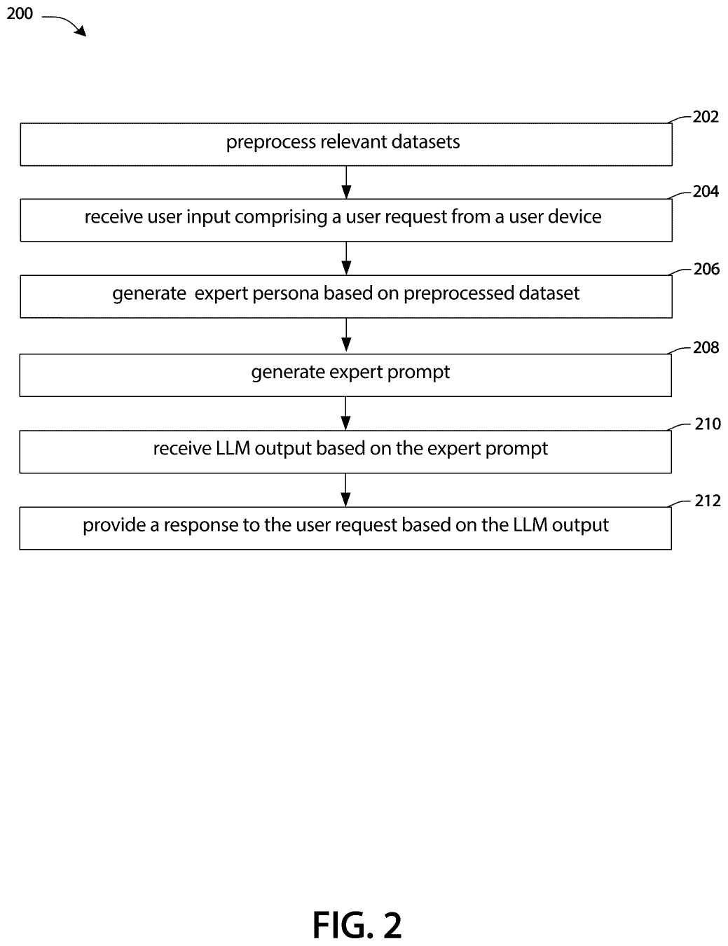

With reference to FIG. 2, at 202 market and historical earnings datasets relevant to an organization may be preprocessed for use in one or more of the embodiments disclosed herein. In general, unless context dictates otherwise, any suitable datasets relevant to the user requested task may be preprocessed in addition.

To preprocess a dataset may include any suitable compilation, validation, indexing, structuring, transformation, maintenance, updating and/or curation of data and/or sets of data, whether manual or automated, or both, sufficient to provide the functionality disclosed herein. In general, a market and historical earnings datasets may be compiled, indexed, structured, maintained, updated, curated, and/or stored in any suitable manner (e.g., indexed and stored in data store 114) sufficient to provide the functionality described herein. For example, in some embodiments, a portion of the market and historical earnings datasets may be stored in a lookup table of data store 114 and indexed according to name, date, institution, etc.

In general, a dataset may comprise any suitable data and sets of data sufficient to allow for market sentiment to be generated by a model, as used in the embodiments described herein. In general, a market sentiment may comprise any characterization (express or implied) of one or more institutions (and/or other market actors') general or particular views concerning an organization or entity, or any aspect (e.g., business, market segment) of the organization or entity. In some embodiments, a market sentiment may comprise consensus estimates (expected results) of key indicators of the organization, expressed wholly or partially in numerical form (e.g., revenue estimates). In other embodiments, a market sentiment may comprise a natural language view relating to the organization. Data of the market dataset may be collected, curated, stored, indexed and organized within the system in generally any suitable manner. In some embodiments, a market dataset may include one or more of the following: transcripts (e.g., earnings calls with financial analysts, analyst question and answer sessions (Q&A), analysis of the organization and/or of competitor organizations; summaries of consensus reports (key indicators) by institutions; conference takeaways reports; stock performance data; analyst reports, social media, etc. on the organization and organization's stock; traffic light reports; regulators'reports and comments, etc.)

In general, a historical earnings dataset may comprise any suitable data and sets of data sufficient to allow for an analyst expert persona to be generated, as used in the embodiments described herein. The data may be collected, curated, stored, indexed and organized within the system in generally any suitable manner. In some embodiments, a historical earnings dataset may include one or more of the following: analysts'questions to an organization made during earnings calls; analysts'questions to competitors made during competitors'earnings calls; transcripts of earnings calls with financial analysts and corresponding analyst question and answer sessions (Q&A) (earnings calls of the organization and/or earnings calls of competitor organizations); historical earnings data (e.g., quarterly earnings data); analyst's institution consensus data; analyst's ratings, beats-vs-misses; etc. It should be noted that any of the foregoing may be collected, generated, stored, and indexed on a quarterly, yearly, etc. basis.

At 204, the system may be configured to receive user input from a user device, such as for example, system 102 receiving user input from user device 104. In general, user input may comprise any suitable user input, made in any suitable manner, sufficient to allow the system to generate meaningful output relevant to the user input, according to one or more embodiments disclosed herein. For example, in some embodiments, user input may comprise one or more data or data sets (e.g., files, tables, strings, data structures, etc.) relating to a user task, together with a user request for the system to perform the user task. Note that unless context dictates otherwise, the terms “user request”, “user task”, and “task” may be used interchangeably herein. In some embodiments, user input may comprise a user dataset relating to the financial performance of an organization, and a user request for the system to provide expert output based on the user dataset.

In some embodiments, user input may comprise earnings data of an organization for the most recent quarter, and/or a draft earnings call transcript for an upcoming earnings call, together with a user request to output a set of generated financial analyst questions to the organization relating to the data input by the user. In particular, in some embodiments, the user request may be for the expert system to generate predicted financial analyst questions of a particular, identified human analyst. In some embodiments, the user request may be for predicted financial analyst questions of a set of particular, identified human analysts (e.g., those affiliated with one or more institutions). In other embodiments, the request may be for predicted financial analyst questions generally and/or with respect to one or more topics of interest. In other embodiments, the request may be for predicted financial analyst questions of a set of analysts belonging to a set of institutions, etc. In some embodiments, the user request may request or instruct the expert system to output generated answers to the requested set of predicted financial analyst questions.

In general, user input may be received in any suitable manner. For example, the user device (e.g., user device 104) may display a user interface communicatively coupled to a portion, subsystem or component of the system (e.g., system 102), wherein the user interface may provide one or more mechanisms that allow a user to provide user input to the system. In some embodiments, the user interface may provide one or more control elements (e.g., buttons, dropdown menus, upload boxes, text fields, etc.) configured to provide a user the ability to upload, externally reference, point to, etc. data to the system and to provide a request for output from the system. For example, in some embodiments, user device 104 may provide a user interface (not shown) that allows a user to upload data (e.g., to data store 114 of framework 110, or another connected data store) and/or reference hosted data (e.g., files, text, lookup tables, etc. hosted externally or in data store 114) and to select, create and/or configure a prompt (e.g., from a preconfigured template of framework 110), in order to specify or otherwise define a user request for system output. For example, in some embodiments, a user may upload the latest earnings data of an organization, as well as draft earnings call transcripts for an upcoming earnings call concerning the latest earnings data, and select a category of output (which may comprise the user request), such as, for example, the set of predicted financial analyst questions and/or answers to such questions referenced in the preceding paragraph, as well as selecting or specifying any ancillary contextual parameters of such request, such as, e.g., the identity of the financial analyst, set of financial analysts, and/or institutions from which the predicted questions should be generated in the persona of.

At 206, an expert persona may be generated based on a relevant dataset of the preprocessed datasets. In particular, in some embodiments, an analyst expert persona may be generated based on the historical earnings dataset. In general, an expert persona may be understood to mean a natural language string that describes an expert in a manner such that a LLM may utilize it as role context in generating insights. In particular, an expert persona may be understood to describe one or more human experts based on a sample set of relevant data from the one or more human experts. In other embodiments described herein, an expert who is the subject of an expert persona (or set of experts who are the subject of an expert persona) may be understood to be an identifiable, human financial analyst (or a set of identifiable, human financial analysts, as the case may be), and the sample set of relevant data may be understood to mean a portion of a relevant historical earnings dataset. The expert or set of experts may be identifiable and/or classified in any suitable manner, such as for example, by individual name, by affiliated institution (e.g., a set of analysts comprising anyone who participated on behalf of an identified institution in one or more earnings calls), etc.

In general, in the embodiments disclosed herein, expert personas may be generated in any suitable manner, based at least in part on one or more preprocessed datasets, sufficient to provide the functionality disclosed herein. In particular, in some embodiments, financial analyst expert personas may be generated in any suitable manner, based at least in part on one or more historical earnings datasets (or a portion thereof). For example, in some embodiments, one or more trained machine learning (ML) models (e.g., convolutional neural networks), algorithms, scripts, programs, code, components, etc., pipelined or organized in any suitable manner, may be utilized to read historical earnings data relevant to one identifiable financial analyst expert and/or a plurality of identifiable financial analyst experts and output a financial analyst expert persona. Model training may be performed in generally any suitable manner sufficient to provide the functionality disclosed herein.

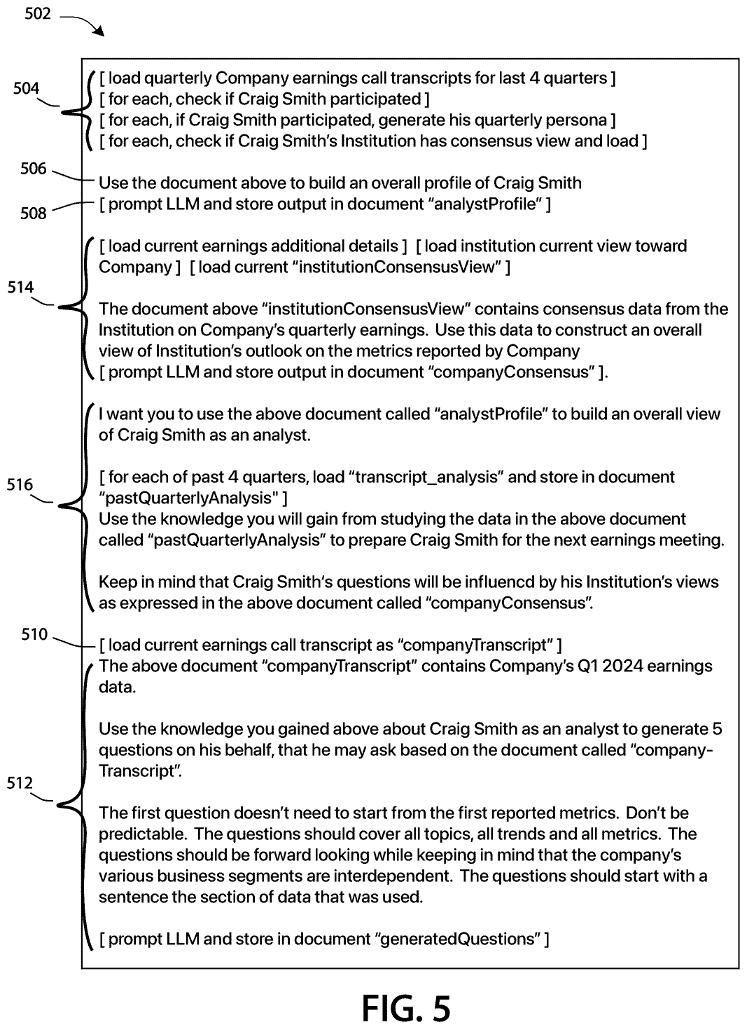

In some embodiments, the machine learning model used to generate an expert persona (e.g., financial analyst expert persona) may comprise an LLM, such as for example, LLM 116 of expert system 102. In such embodiments, generally any suitable manner of prompting the LLM sufficient to output an expert persona according to the embodiments described herein may be utilized. For example, in some embodiments, a natural language LLM prompt instructing the LLM to reference a relevant expert persona dataset and output a natural language description of the expert, using one or more criteria (hereinafter referred to as an expert persona generation prompt) may be used to prompt the LLM. In some embodiments, the expert persona generation prompt may be utilized to prompt the LLM (e.g., LLM 116) to generate the expert persona and to output the results as a string, document, data structure, file, etc. to be indexed, curated, stored and/or utilized by system 102 thereafter. In other embodiments, the expert persona generation prompt may comprise a portion of an expert prompt (e.g., a financial analyst expert prompt), as described in further detail below in relation to FIG. 5, below. In some embodiments, the relevant expert persona dataset may comprise a portion of the historical earnings dataset. In some embodiments, the portion may be selected based on an identifiable human financial analyst expert and/or a set of identifiable financial analyst experts (e.g. the set of analysts affiliated with a single institution, or a plurality of institutions). In some embodiments, the one or more criteria may be selected by the system based on the user input (e.g., user request). In some embodiments, the one or more criteria may comprise: the financial analyst's sentiment toward the organization, whether the financial analyst focuses on one or more (pre-defined) topics of interest, the financial analyst's methodology and demeanor, the financial analyst's tendencies, the financial analyst's areas of interest (not pre-defined or limited), etc. In some embodiments, the pre-defined topics of interest may comprise: consolidated financials topics, consumer-related topics, business topics, balance sheet topics, business-sector subject matter topics, miscellaneous topics, etc.

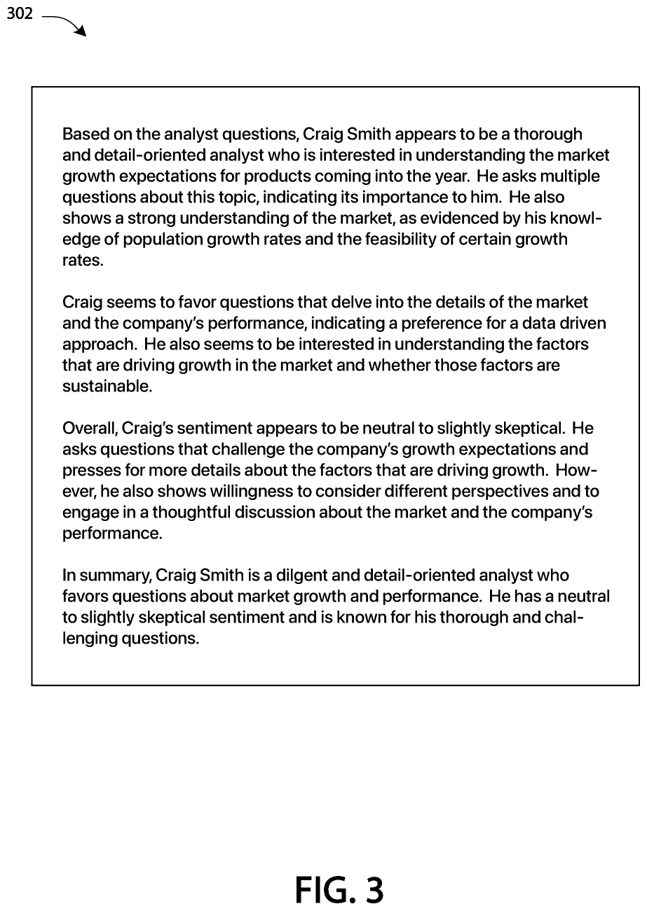

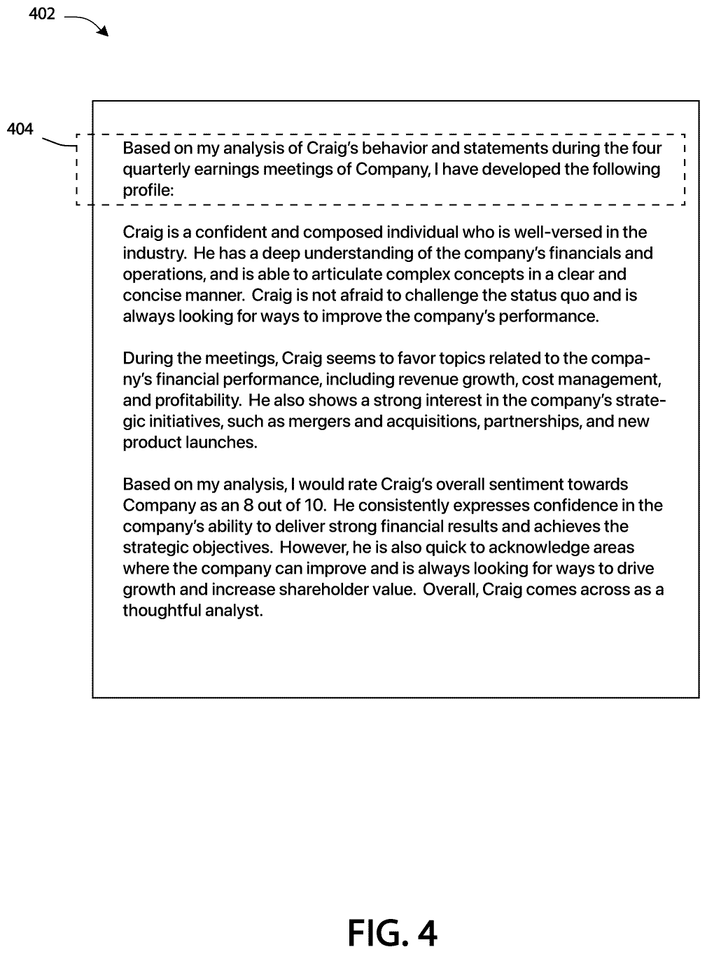

With reference to FIG. 3, illustrated is an exemplary financial analyst expert persona 302 according to one or more embodiments herein. As may be seen, persona 302 is a natural language description of a single identifiable (and identified by name, Craig Smith) human analyst. As may be appreciated, in some embodiments, in relation to the exemplary expert persona 302, a user request specifying LLM output based on an identified financial analyst (Craig Smith) may cause the system to use an expert persona generating prompt resulting in persona 302. The expert persona generating prompt (not shown) used to generate expert persona 302 supplies the LLM with (or provides the LLM with reference to) a portion of the historical earnings dataset—e.g., a single quarter's earnings call transcript and Q&A (or just those portions and questions relevant to the financial analyst) for an organization (the “Company” referenced in expert persona 302) and instructs the LLM to output a description along one or more criteria, as gleaned from this example. In some embodiments, the expert generating prompt may also supply the LLM with one or more personas previously generated for the financial analysts and may instruct the LLM to base the newly generated persona based in part on the one or more previously generated personas, as described further in relation to FIGS. 4 & 5, below.

With reference to FIG. 4, illustrated is another exemplary financial analyst expert persona 402 according to one or more embodiments herein. As may be seen, expert persona 402 is another natural language description of a human financial analyst, Craig Smith. The expert persona generating prompt (not shown) used to generate expert persona 402 supplies the LLM with (or provides the LLM with reference to) one or more previously-generated personas and instructs the LLM to output a description that is based in part on the one or more previously generated personas, along one or more criteria, as gleaned from this example. In particular, as may be appreciated from portion 404 of expert persona 402, the expert persona generating prompt utilized to generate expert persona 404 supplied the LLM (e.g., LLM 116) with four previously-generated expert persona for analyst Craig Smith, each generated using Company earnings call data from a single quarter, for the prior four quarters. Additional description of such prompting is disclosed in relation to FIG. 5, below.

In general, the generated expert personas may be curated, indexed and stored in any suitable manner sufficient to provide the functionality described herein. For example, in some embodiments, the financial analyst expert personas may be stored in a lookup table of data store 114 and indexed according to name, date, institution, etc.

At 208, an expert prompt may be generated. In some embodiments, at 208, a financial analyst expert prompt may be generated. In general, the system may be configured in any suitable manner to generate expert prompts, sufficient to provide the functionality described herein. For example, in some embodiments, financial analyst expert prompts may be created and/or configured (e.g., as from templates) by framework 110 and/or using framework 110 and executed on a connected LLM (e.g., LLM 116). As used herein, unless context dictates otherwise, a financial analyst expert prompt may be understood to mean an LLM prompt comprising a primary financial analyst expert persona and a primary persona instruction. A financial analyst expert prompt may comprise at least one dataset to be analyzed (e.g., earnings data provided as part of a user request). In general, a primary financial analyst expert persona be an expert persona utilized in a financial analyst expert prompt as the primary persona context with which the LLM is instructed to adopt in providing responsive output to a user request. Also, in general, a primary persona instruction may be a portion of an LLM prompt that references a primary expert persona (e.g., a primary financial analyst expert persona) in requesting LLM output responsive to a user request.

With reference now to FIG. 5, illustrated is an exemplary financial analyst expert prompt 502 according to one or more embodiments herein. As may be seen, prompt 502 comprises a natural language LLM prompt. As noted above, in some embodiments, the system (e.g., system 102) may prompt a communicatively connected LLM (e.g., LLM 116) in any suitable manner, such as via one or more frameworks (e.g., framework 110) or framework components (e.g., arbitrator 112) using one or more tools, modules, prompt templates, etc. Referring to FIG. 5, it may be seen that a financial analyst expert prompt as used herein (e.g., prompt 502) may comprise, in some embodiments, one or more functional elements (e.g., framework markup or template language elements), as illustrated by bracketed portions of prompt 502 (e.g., portions 504), in addition to one or more natural language portions (e.g., portion 506). In general, functional elements of a natural language LLM prompt, as used herein, may interact with one or more subsystems, modules, components, etc. of the system (e.g., system 102) to accomplish prompting of an LLM to generate LLM output responsive to a user request. For example, with reference to prompt 502, one or more functional elements of prompt 502 (e.g., represented by portion 504) may interact with system data stores (e.g., data store 114) to load, access, read, write, save, and/or update one or more stored files, documents, table entries, strings, etc., while other functional elements (e.g., represented by portion 506) may interact with a system LLM (e.g., LLM 116) to execute the functional element on the LLM (as by, e.g., calling an LLM API function). It should be noted that the exemplary form of prompts shown in FIGS. 5-7 are not intended to be limiting; rather, a prompt may take the form, format, text, language, etc. of the example prompts, or they may be changed and still be within the spirit and scope of the embodiments described herein. For example, as understood, the bracketed notation and text descriptions within the bracket portions are merely descriptive of functional prompting elements, and do not represent particular form or format of any functional language or language elements (i.e. it is in the nature of pseudocode notation).

At 210, the system may be configured to receive LLM output based on the expert prompt, such as for example, system 102 (framework 110) receiving output from LLM 116 in response to LLM 116 being prompted by system 102 (framework 110) using the financial analyst expert prompt generated at 208. Referring again to FIG. 5, in some embodiments the financial analyst expert prompt generated at 208 may include one or more portions that are responsible for providing a primary financial analyst expert persona to the LLM. For example, with respect to prompt 502, portion 504, 506, 508: (1) supplies LLM 116 with a relevant portion of the historical earnings dataset (e.g., the last four quarterly earnings call transcripts of Company), (2) prompts LLM 116 to generate quarterly financial analyst expert personas for each quarterly earnings call transcript in which a criteria is satisfied (e.g., whether analyst Craig Smith participated, as may be specified based on, for example, a user request), (3) supplies LLM 116 with relevant portions of a market dataset (e.g., any relevant Institution consensus views on the Company for each relevant quarter), and (4) instructs the LLM to build an overall financial analyst expert persona using the supplied data as context, via instruction 506. At portion 508, the functional element 508 may cause framework 110 to receive and store the output overall persona (functioning as the primary financial analyst expert persona with respect to prompt 502) as a document named “analystProfile”.

As may be appreciated after reading the foregoing, in some embodiments of the systems and methods disclosed herein, a financial analyst expert prompt may utilize (load, reference, etc.) one or more previously generated and stored financial analyst expert personas, such as, e.g., a persona similar to that illustrated and described in relation to FIGS. 3 and 4 above. In other embodiments, a financial analyst expert prompt may comprise one or more portions (e.g., portions 504, 506, 508 of prompt 502) that are responsible for providing a primary financial analyst expert persona to the LLM, in addition to or in lieu of referencing or loading a previously stored persona. In that sense, in some embodiments herein, a financial analyst expert prompt (e.g., prompt 502) may comprise an expert persona generation prompt.

Referring still to FIG. 5, in some embodiments, a financial analyst expert prompt may include at least one dataset to be analyzed using the primary persona prompt. For example, with respect to prompt 502, portion 510 may comprise current earnings data. In particular, in prompt 502, the dataset may comprise Company's current quarterly earnings call transcript; in some embodiments, the dataset may have been uploaded by a user as part of a user request. In some embodiments, such as in exemplary prompt 502, the dataset to be analyzed may be provided via a framework functional element (e.g., a reference to stored data to be loaded upon executing the prompt on LLM 116).

As illustrated in FIG. 5, in some embodiments, a financial analyst expert prompt may include one or more portions that are responsible for providing a primary persona instruction to the LLM. For example, with respect to prompt 502, portion 512: (1) references the dataset to be analyzed; (2) requests the LLM to generate output based on the referenced dataset; and (3) provides role context to the LLM based on the primary financial analyst expert persona with which to respond to the request. As shown, in this embodiment, portion 512 requests the connected LLM to generate analyst questions using the primary financial analyst expert persona (e.g., the persona generated by portions 504, 506, 508) as the role in generating the questions. Also, as shown, in this embodiment, prompt 502 comprises one or more functional elements causing the system to store the received LLM output as a document file.

In some embodiments, the financial analyst expert prompt may include one or more portions that are responsible for providing current earnings data and/or market sentiment to the LLM, for use as additional context. For example, with respect to prompt 502, portion 514: (1) supplies LLM 116 with a relevant portion of the current Company earnings data (e.g., current earnings data, other than current earning call transcript, as may be uploaded by a user as part of a user request); (2) supplies a relevant portion of a market dataset (e.g., current view of Company by a particular institution—e.g., the institution affiliated with the relevant financial analyst of the prompt—as well as current view of Company by a set of institutions); (3) requests LLM 116 to generate an overall market sentiment based on the supplied portions of the market dataset; and (4) causes framework 110 to receive and store the output market sentiment as a file (e.g., document) named “companyConsensus”.

In some embodiments, the financial analyst expert prompt may include one or more portions that are responsible for providing expert training to the LLM, for use as additional context. Expert training may be an expert role instruction that is in addition to the primary persona instruction. For example, with respect to prompt 502, portion 516: (1) supplies LLM 116 with an additional relevant portion of the market or historical earnings dataset (e.g., additional market analyses of the last four quarterly earnings call transcripts of Company); and (2) instructs the LLM to prepare the expert analyst for generating the requested output by using the additional relevant portions.

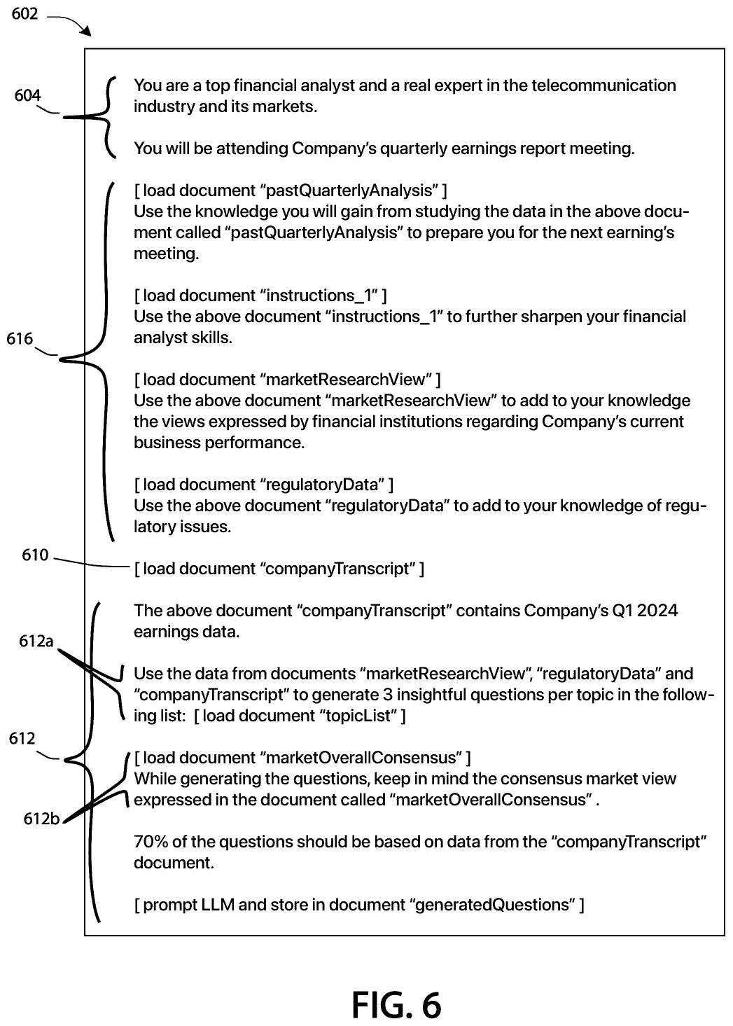

With reference to FIG. 6, illustrated is another exemplary financial analyst expert prompt 602 according to one or more embodiments herein. As may be seen, prompt 602 comprises portion 604 that is responsible for providing a primary financial analyst expert persona to the LLM. As shown, portion 604 does not instruct for an expert persona that describes an identifiable human expert, unlike other embodiments described herein, but instead for one that describes a general human expert (i.e., “top financial analyst and real expert in the telecommunication industry and its markets”).

As shown in FIG. 6, prompt 602. comprises portions 616 that provide for expert training of the primary financial analyst expert persona. For example, as may be seen in FIG. 6, portions 616: (1) supplies LLM 116 with relevant portions of the market or historical earnings dataset (e.g., market analyses of historical quarterly earnings data, regulatory data); and (2) instructs the LLM to prepare the expert analyst for generating the requested output by considering the additional relevant portions.

Referring still to FIG. 6, exemplary financial analyst expert prompt 602 comprises portions that are responsible for providing a primary persona instruction to the LLM. For example, with respect to prompt 602, portion 612: (1) references the dataset to be analyzed (the Company's current earnings call transcript, referenced at portion 610); and (2) requests the LLM to generate output based on the referenced dataset.

As shown, in this embodiment, portion 612a of the primary persona instruction 612 comprises request for the LLM (as trained by the expert persona described at 604 and as additionally trained at 616) to generate three earnings call financial analyst questions per topic drawn from a pre-configured list of topics. Also as shown, in this embodiment, portion 612b of the primary persona instruction comprises market sentiment information (e.g., accessed in stored document titled “marketOverallConsensus”) and an instruction to generate the requested output with the market sentiment as context. Portion 612 concludes with one or more functional elements causing the system to store the received LLM output as a document file titled “generated Questions”.

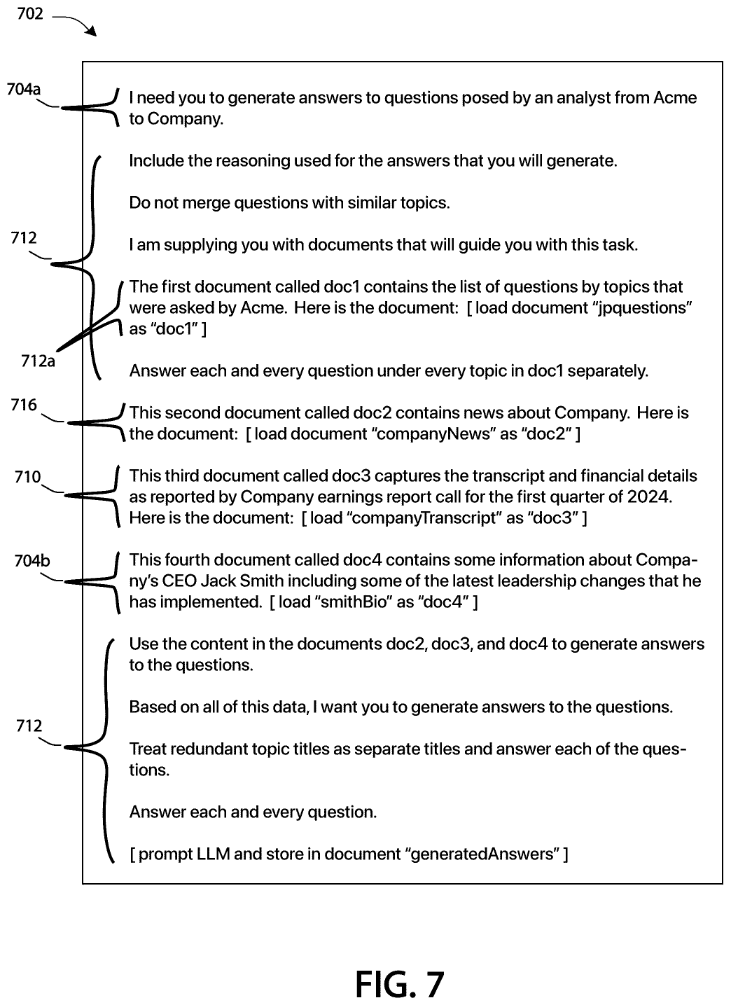

With reference to FIG. 7, illustrated is one, non-limiting example of an expert prompt 702 according to some embodiments disclosed herein. As shown, expert prompt 702 comprises portion 704(a),(b), that is responsible for providing a primary expert persona to the LLM (e.g., LLM 116). As indicated from portion 704(b), an expert persona resulting from prompting with portions 704 would not correspond to or describe a financial analyst per se, but rather would correspond to or describe Company CEO Jack Smith (i.e., an identified human CEO).

As shown in FIG. 7, in some embodiments, an expert prompt may include at least one dataset to be analyzed using the primary persona prompt. For example, with respect to prompt 702, portion 710 may comprise current earnings data. In particular, in prompt 702, the dataset may comprise Company's current quarterly earnings call transcript; in some embodiments, the dataset may have been uploaded by a user as part of a user request. In some embodiments, such as in exemplary prompt 702, the dataset to be analyzed may be provided via a framework functional element (e.g., a reference to stored data to be loaded upon executing the prompt on LLM 116).

As illustrated in FIG. 7, in some embodiments, an expert prompt may include one or more portions that are responsible for providing a primary persona instruction to the LLM. For example, with respect to prompt 702, portion 712: (1) references the dataset to be analyzed; (2) requests the LLM to generate output based on the referenced dataset; and (3) provides role context to the LLM based on the primary expert persona with which to respond to the request. As shown, in this embodiment, portion 712 requests the connected LLM to generate answers to financial analyst questions provided using portion 712a, using the primary expert persona (e.g., the persona generated by portions 704) as the role in generating the questions. Also, as shown, in this embodiment, prompt 702 comprises one or more functional elements causing the system to store the received LLM output as a document file.

In some embodiments, the expert prompt may include one or more portions that are responsible for providing historical earnings data and/or market data to the LLM, for use as additional context. For example, with respect to prompt 702, portion 714 supplies LLM 116 with a relevant portion of the market dataset (e.g., news about Company and, as part of primary persona instruction 712, instructs the connected LLM to refer to the market data as context in generating output.

As may be appreciated, in some embodiments, all or portions of an expert persona prompt (e.g., prompt 702) may be combined with (e.g., concatenated with, prompted as part of a common session with, etc.) all or portions of a financial analyst expert persona prompt (e.g., prompt 502), according to aspects of embodiments disclosed herein. In this manner, a common session context may be utilized to perform multiple functions, such as for example, generating financial analyst questions and CEO responses to all or a portion of those questions, using common context and data.

Referring again to FIG. 2, at 212, the system may be configured to provide a response to the user request based on the LLM output. For example, in some embodiments, system 102 may be configured to display all or a portion of the LLM output on the user's client device (e.g., device 104). For example, in some embodiments, framework 110 of system 102 may be configured to receive and parse LLM output and provide the parsed output to application 108 for display on a user interface (not shown) executing device 104.

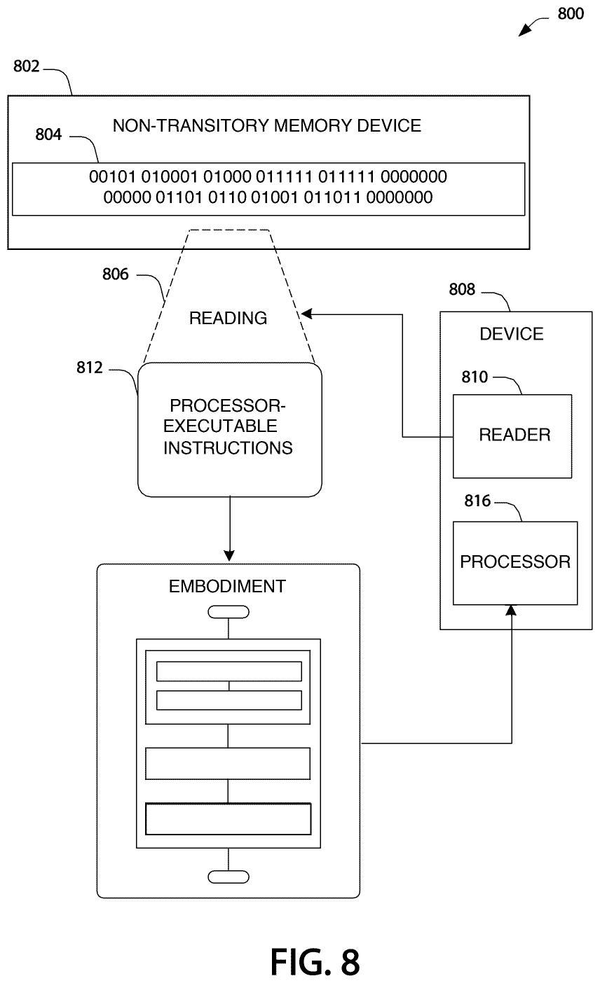

FIG. 8 is an illustration of a scenario 800 involving an example non-transitory machine readable medium 802. The non-transitory machine readable medium 802 may comprise processor-executable instructions 812 that when executed by a processor 816 cause performance (e.g., by the processor 816) of at least some of the provisions herein. The non-transitory machine readable medium 802 may comprise a memory semiconductor (e.g., a semiconductor utilizing static random access memory (SRAM), dynamic random access memory (DRAM), and/or synchronous dynamic random access memory (SDRAM) technologies), a platter of a hard disk drive, a flash memory device, or a magnetic or optical disc (such as a compact disk (CD), a digital versatile disk (DVD), or floppy disk). The example non-transitory machine readable medium 802 stores computer-readable data 804 that, when subjected to reading 806 by a reader 810 of a device 808 (e.g., a read head of a hard disk drive, or a read operation invoked on a solid-state storage device), express the processor-executable instructions 812. In some embodiments, the processor-executable instructions 812, when executed cause performance of operations, such as at least some of the example method 200 of FIG. 2, for example. In some embodiments, the processor-executable instructions 812 are configured to cause implementation of a system, such as at least some of the example system 102 of FIG. 1.

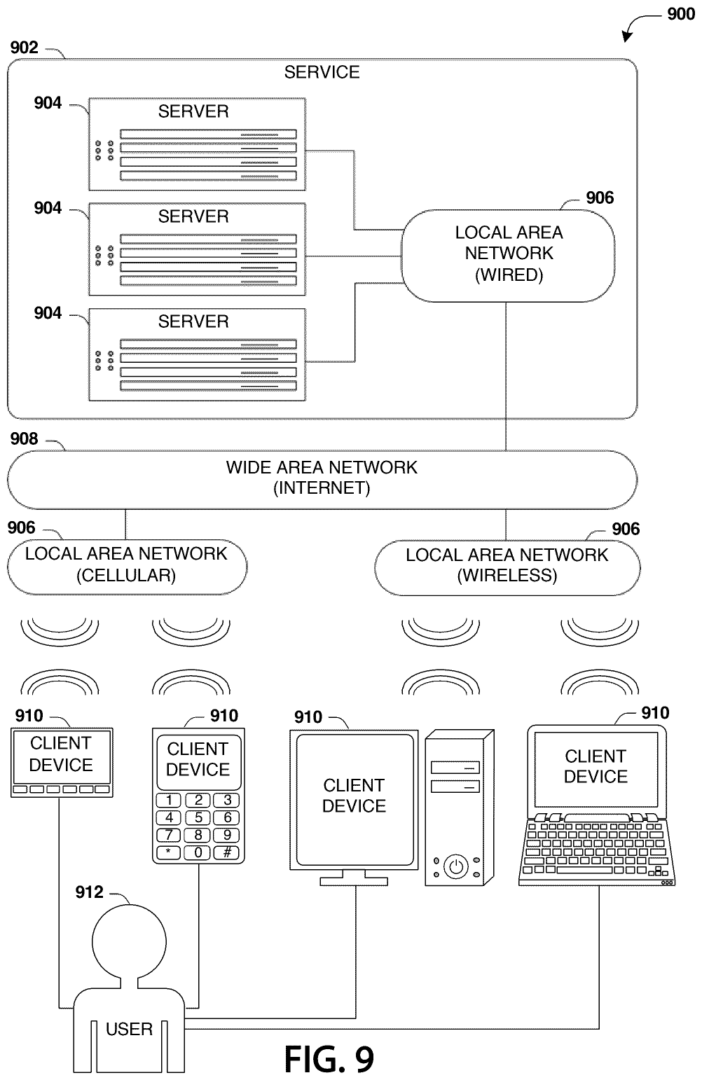

FIG. 9 is an interaction diagram of a scenario 900 illustrating a service 902 provided by a set of computers 904 to a set of client devices 910 via various types of transmission mediums. The computers 904 and/or client devices 910 may be capable of transmitting, receiving, processing, and/or storing many types of signals, such as in memory as physical memory states. In some embodiments, the computers 904 may be host devices and/or the client device 910 may be devices attempting to communicate with the computer 904 over buses for which device authentication for bus communication is implemented.

The computers 904 of the service 902 may be communicatively coupled together, such as for exchange of communications using a transmission medium 906. The transmission medium 906 may be organized according to one or more network architectures, such as computer/client, peer-to-peer, and/or mesh architectures, and/or a variety of roles, such as administrative computers, authentication computers, security monitor computers, data stores for objects such as files and databases, business logic computers, time synchronization computers, and/or front-end computers providing a user-facing interface for the service 902.

Likewise, the transmission medium 906 may comprise one or more sub-networks, such as may employ different architectures, may be compliant or compatible with differing protocols and/or may interoperate within the transmission medium 906. Additionally, various types of transmission medium 906 may be interconnected (e.g., a router may provide a link between otherwise separate and independent transmission medium 906).

In scenario 900 of FIG. 9, the transmission medium 906 of the service 902 is connected to a transmission medium 908 that allows the service 902 to exchange data with other services 902 and/or client devices 910. The transmission medium 908 may encompass various combinations of devices with varying levels of distribution and exposure, such as a public wide-area network and/or a private network (e.g., a virtual private network (VPN) of a distributed enterprise).

In the scenario 900 of FIG. 9, the service 902 may be accessed via the transmission medium 908 by a user 912 of one or more client devices 910, such as a portable media player (e.g., an electronic text reader, an audio device, or a portable gaming, exercise, or navigation device); a portable communication device (e.g., a camera, a phone, a wearable or a text chatting device); a workstation; and/or a laptop form factor computer. The respective client devices 910 may communicate with the service 902 via various communicative couplings to the transmission medium 908. As a first such example, one or more client devices 910 may comprise a cellular communicator and may communicate with the service 902 by connecting to the transmission medium 908 via a transmission medium 909 provided by a cellular provider. As a second such example, one or more client devices 910 may communicate with the service 902 by connecting to the transmission medium 908 via a transmission medium 909 provided by a location such as the user's home or workplace (e.g., a Wi-Fi (Institute of Electrical and Electronics Engineers (IEEE) Standard 802.11) network or a Bluetooth (IEEE Standard 802.15.1) personal area network). In this manner, the computers 904 and the client devices 910 may communicate over various types of transmission mediums.

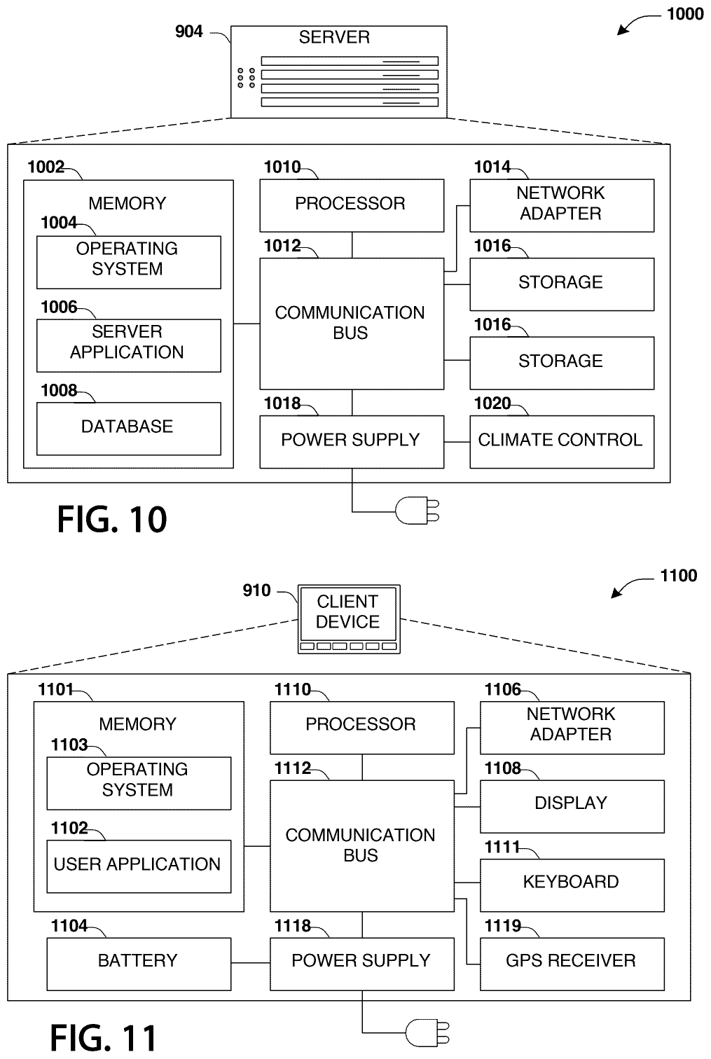

FIG. 10 presents a schematic architecture diagram 1000 of a computer 904 that may utilize at least a portion of the techniques provided herein. Such a computer 904 may vary widely in configuration or capabilities, alone or in conjunction with other computers, in order to provide a service. The computer 904 may comprise one or more processors 1010 that process instructions. The one or more processors 1010 may optionally include a plurality of cores; one or more coprocessors, such as a mathematics coprocessor or an integrated graphical processing unit (GPU); and/or one or more layers of local cache memory. The computer 904 may comprise memory 1002 storing various forms of applications, such as an operating system 904; one or more computer applications 1006; and/or various forms of data, such as a database 1008 or a file system. The computer 904 may comprise a variety of peripheral components, such as a wired and/or wireless network adapter 1014 connectible to a local area network and/or wide area network; one or more storage components 1016, such as a hard disk drive, a solid-state storage device (SSD), a flash memory device, and/or a magnetic and/or optical disk reader.

The computer 904 may comprise a mainboard featuring one or more communication buses 1012 that interconnect the processor 1010, the memory 1002, and various peripherals, using a variety of bus technologies, such as a variant of a serial or parallel AT Attachment (ATA) bus protocol; a Uniform Serial Bus (USB) protocol; and/or Small Computer System Interface (SCI) bus protocol. In a multibus scenario, a communication bus 1012 may interconnect the computer 904 with at least one other computer. Other components that may optionally be included with the computer 904 (though not shown in the schematic architecture diagram 1000 of FIG. 10) include a display; a display adapter, such as a graphical processing unit (GPU); input peripherals, such as a keyboard and/or mouse; and a flash memory device that may store a basic input/output system (BIOS) routine that facilitates booting the computer 904 to a state of readiness.

The computer 904 may operate in various physical enclosures, such as a desktop or tower, and/or may be integrated with a display as an “all-in-one” device. The computer 904 may be mounted horizontally and/or in a cabinet or rack, and/or may simply comprise an interconnected set of components. The computer 904 may comprise a dedicated and/or shared power supply 1018 that supplies and/or regulates power for the other components. The computer 904 may provide power to and/or receive power from another computer and/or other devices. The computer 904 may comprise a shared and/or dedicated climate control unit 1020 that regulates climate properties, such as temperature, humidity, and/or airflow. Many such computers 904 may be configured and/or adapted to utilize at least a portion of the techniques presented herein.

FIG. 11 presents a schematic architecture diagram 1100 of a client device 910 whereupon at least a portion of the techniques presented herein may be implemented. Such a client device 910 may vary widely in configuration or capabilities, in order to provide a variety of functionality to a user such as the user 712. The client device 910 may be provided in a variety of form factors, such as a desktop or tower workstation; an “all-in-one” device integrated with a display 1108; a laptop, tablet, convertible tablet, or palmtop device; a wearable device mountable in a headset, eyeglass, earpiece, and/or wristwatch, and/or integrated with an article of clothing; and/or a component of a piece of furniture, such as a tabletop, and/or of another device, such as a vehicle or residence. The client device 910 may serve the user in a variety of roles, such as a workstation, kiosk, media player, gaming device, and/or appliance.

The client device 910 may comprise one or more processors 1110 that process instructions. The one or more processors 1110 may optionally include a plurality of cores; one or more coprocessors, such as a mathematics coprocessor or an integrated graphical processing unit (GPU); and/or one or more layers of local cache memory. The client device 910 may comprise memory 1101 storing various forms of applications, such as an operating system 1103; one or more user applications 1102, such as document applications, media applications, file and/or data access applications, communication applications such as web browsers and/or email clients, utilities, and/or games; and/or drivers for various peripherals. The client device 910 may comprise a variety of peripheral components, such as a wired and/or wireless network adapter 1106 connectible to a local area network and/or wide area network; one or more output components, such as a display 1108 coupled with a display adapter (optionally including a graphical processing unit (GPU)), a sound adapter coupled with a speaker, and/or a printer; input devices for receiving input from the user, such as a keyboard 1111, a mouse, a microphone, a camera, and/or a touch-sensitive component of the display 1108; and/or environmental sensors, such as a global positioning system (GPS) receiver 1119 that detects the location, velocity, and/or acceleration of the client device 910, a compass, accelerometer, and/or gyroscope that detects a physical orientation of the client device 910. Other components that may optionally be included with the client device 910 (though not shown in the schematic architecture diagram 1100 of FIG. 11) include one or more storage components, such as a hard disk drive, a solid-state storage device (SSD), a flash memory device, and/or a magnetic and/or optical disk reader; and/or a flash memory device that may store a basic input/output system (BIOS) routine that facilitates booting the client device 910 to a state of readiness; and a climate control unit that regulates climate properties, such as temperature, humidity, and airflow.

The client device 910 may comprise a mainboard featuring one or more communication buses 1112 that interconnect the processor 1110, the memory 1101, and various peripherals, using a variety of bus technologies, such as a variant of a serial or parallel AT Attachment (ATA) bus protocol; the Uniform Serial Bus (USB) protocol; and/or the Small Computer System Interface (SCI) bus protocol. The client device 910 may comprise a dedicated and/or shared power supply 1118 that supplies and/or regulates power for other components, and/or a battery 1104 that stores power for use while the client device 910 is not connected to a power source via the power supply 1118. The client device 910 may provide power to and/or receive power from other client devices.

As used in this application, “component,” “module,” “system”, “interface”, and/or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component may be localized on one computer and/or distributed between two or more computers.

Unless specified otherwise, “first,” “second,” and/or the like are not intended to imply a temporal aspect, a spatial aspect, an ordering, etc. Rather, such terms are merely used as identifiers, names, etc. for features, elements, items, etc. For example, a first object and a second object generally correspond to object A and object B or two different or two identical objects or the same object.

Moreover, “example” and “exemplary” are used herein to mean serving as an example, instance, illustration, etc., and not necessarily as advantageous. As used herein, “or” is intended to mean an inclusive “or” rather than an exclusive “or”. In addition, “a” and “an” as used in this application are generally construed to mean “one or more” unless specified otherwise or clear from context to be directed to a singular form. Also, at least one of A and B and/or the like generally means A or B or both A and B. Furthermore, to the extent that “includes”, “having”, “has”, “with”, and/or variants thereof are used in either the detailed description or the claims, such terms are intended to be inclusive in a manner similar to the term “comprising”.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing at least some of the claims.

Furthermore, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

Various operations of embodiments are provided herein. In an embodiment, one or more of the operations described may constitute computer readable instructions stored on one or more computer readable media, which if executed by a computing device, will cause the computing device to perform the operations described. The order in which some or all of the operations are described should not be construed as to imply that these operations are necessarily order dependent. Alternative ordering may be implemented without departing from the scope of the disclosure. Further, it will be understood that not all operations are necessarily present in each embodiment provided herein. Also, it will be understood that not all operations are necessary in some embodiments.

Also, although the disclosure has been shown and described with respect to one or more implementations, alterations and modifications may be made thereto and additional embodiments may be implemented based upon a reading and understanding of this specification and the annexed drawings. The disclosure includes all such modifications, alterations and additional embodiments and is limited only by the scope of the following claims. The specification and drawings are accordingly to be regarded in an illustrative rather than restrictive sense. In particular regard to the various functions performed by the above described components (e.g., elements, resources, etc.), the terms used to describe such components are intended to correspond, unless otherwise indicated, to any component which performs the specified function of the described component (e.g., that is functionally equivalent), even though not structurally equivalent to the disclosed structure. In addition, while a particular feature of the disclosure may have been disclosed with respect to only one of several implementations, such feature may be combined with one or more other features of the other implementations as may be desired and advantageous for any given or particular application.

In the preceding specification, various example embodiments have been described with reference to the accompanying drawings. It will, however, be evident that various modifications and changes may be made thereto, and additional embodiments may be implemented, without departing from the broader scope of the invention as set forth in the claims that follow. The specification and drawings are accordingly to be regarded in an illustrative rather than restrictive sense. To the extent the aforementioned implementations collect, store, or employ personal information of individuals, groups or other entities, it should be understood that such information shall be used in accordance with all applicable laws concerning protection of personal information. Additionally, the collection, storage, and use of such information can be subject to consent of the individual to such activity, for example, through well known “opt-in” or “opt-out” processes as can be appropriate for the situation and type of information. Storage and use of personal information can be in an appropriately secure manner reflective of the type of information, for example, through various access control, encryption and anonymization techniques for particularly sensitive information.

What is claimed:

1. A system comprising:
at least one processor; and
memory storing instructions that, when executed by the at least one processor, cause the system to perform a set of operations, the set of operations comprising:
receiving, from a user device, user input to a model framework communicatively coupled to a large language model (LLM), wherein the user input comprises a user request;
accessing a dataset relevant to the user input;
generating a task-specific expert persona based on the dataset;
generating, by the model framework, a task-specific expert prompt;
receiving LLM output based on the task-specific expert prompt; and
providing a response to the user request based on the LLM output.

2. The system of claim 1 wherein generating the task-specific expert persona is further based on a previously-generated task-specific expert persona.

3. The system of claim 1 wherein generating the task-specific expert persona is generated by the LLM.

4. The system of claim 1 wherein generating the task-specific expert persona comprises prompting, by the model framework, the LLM with an expert persona generation prompt, wherein the expert persona generation prompt comprises a previously-generated task-specific expert persona selected based on the user request.

5. The system of claim 3 wherein receiving LLM output based on the task-specific expert prompt comprises prompting, by the model framework, the LLM with the task-specific expert prompt, and wherein providing a response to the user request based on the LLM output comprises displaying the response on the user device.

6. The system of claim 5 wherein the task-specific expert prompt comprises the task-specific expert persona and a persona instruction, at least a portion of the dataset relevant to the user input, and a request for output based on the user request, and wherein the persona instructions comprise text that, when issued in a prompt to the LLM, cause the LLM to use the task-specific expert persona as context in generating the LLM output.

7. The system of claim 6 wherein the task-specific expert persona comprises text that describes a human task-specific expert.

8. The system of claim 6 wherein the task-specific expert persona comprises text that describes a set of task-specific experts.

9. A method comprising:
receiving, from a user device, user input to a model framework communicatively coupled to a large language model (LLM), wherein the user input comprises a user request;
accessing a dataset relevant to the user input;
generating a task-specific expert persona based on the dataset;
generating, by the model framework, a task-specific expert prompt;
receiving LLM output based on the task-specific expert prompt; and
providing a response to the user request based on the LLM output.

10. The method of claim 9 wherein generating the task-specific expert persona is further based on a previously-generated task-specific expert persona.

11. The method of claim 9 wherein generating the task-specific expert persona is generated by the LLM.

12. The method of claim 9 wherein generating the task-specific expert persona comprises prompting, by the model framework, the LLM with an expert persona generation prompt, wherein the expert persona generation prompt comprises a previously-generated task-specific expert persona selected based on the user request.

13. The method of claim 11 wherein receiving LLM output based on the task-specific expert prompt comprises prompting, by the model framework, the LLM with the task-specific expert prompt, and wherein providing a response to the user request based on the LLM output comprises displaying the response on the user device.

14. The method of claim 13 wherein the task-specific expert prompt comprises the task-specific expert persona and a persona instruction, at least a portion of the dataset relevant to the user input, and a request for output based on the user request, and wherein the persona instructions comprise text that, when issued in a prompt to the LLM, cause the LLM to use the task-specific expert persona as context in generating the LLM output.

15. The method of claim 14 wherein the task-specific expert persona comprises text that describes a human task-specific expert.

16. The method of claim 14 wherein the task-specific expert persona comprises text that describes a set of task-specific experts.

17. A non-transitory computer-readable medium storing instructions that when executed facilitate performance of operations comprising:
receiving, from a user device, user input to a model framework communicatively coupled to a large language model (LLM), wherein the user input comprises a user request;
accessing a dataset relevant to the user input;
generating a task-specific expert persona based on the dataset;
generating, by the model framework, a task-specific expert prompt;
receiving LLM output based on the task-specific expert prompt; and
providing a response to the user request based on the LLM output.

18. The non-transitory computer-readable medium of claim 17 wherein generating the task-specific expert persona is further based on a previously-generated task-specific expert persona.

19. The non-transitory computer-readable medium of claim 17 wherein generating the task-specific expert persona is generated by the LLM.

20. The non-transitory computer-readable medium of claim 17 wherein receiving LLM output based on the task-specific expert prompt comprises prompting, by the model framework, the LLM with the task-specific expert prompt, and wherein providing a response to the user request based on the LLM output comprises displaying the response on the user device.
